(19) United States
(12) Patent Application Publication
(10) Pub. No.: US 2010/0319442 A1
(43) Pub. Date: Dec. 23, 2010

(54) METHOD FOR TESTING A DRIVE ARRANGEMENT AND ACCORDINGLY EQUIPPED CONVERTER

(75) Inventor: Erich Bott, Hollstadt (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, Munchen (DE)

(21) Appl. No.: 12/528,156

(22) PCT Filed: Feb. 28, 2008
(86) PCT No.: PCT/EP2008/052401

§ 371 Date: Aug. 21, 2009

(30) Foreign Application Priority Data
Mar. 2, 2007 (DE) 10 2007 010 281.1

(51) Int. Cl. G01M 15/00

(52) U.S. Cl. 73/114.26

(57) ABSTRACT

In a method according to the invention for testing a drive arrangement and an accordingly equipped converter, an actual torsional backlash of an engine brake, which is preferably configured as a spring-operated brake, is determined and compared to a permitted torsional backlash. To this end, a test torque, which is smaller than a holding torque of the brake, is moved counter to the closed brake up to a stop, preferably in both directions of rotation. The testing method can be implemented as a routine check in a converter of the drive arrangement.

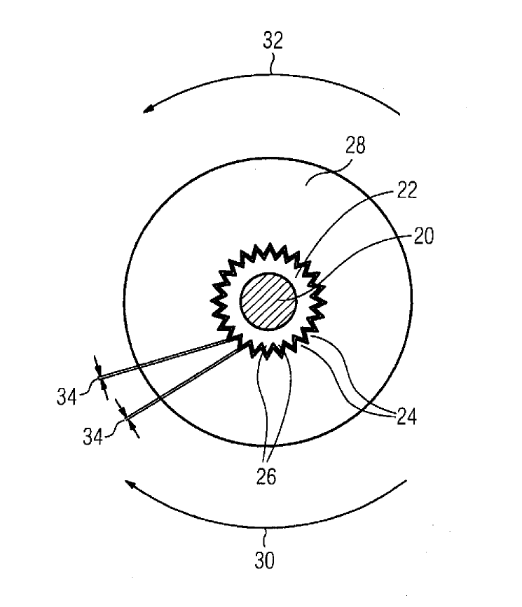

The invention relates to a method for testing a drive arrangement, the drive arrangement comprising at least one engine which drives a shaft, and also a safety brake for stopping the engine safely. The invention relates, furthermore, to a converter which is equipped, inter alia, for testing a drive arrangement of this type.

In a large number of drive solutions, it is necessary for the engines to be stopped safely, for which purpose a safety brake, as it is known, is usually provided. Safety brakes of this type may be designed, for example, as spring pressure brakes with a brake disk. This type of brake is relatively cost-effective, and, even in the event of progressive wear, at least a residue of braking action is still present.

However, a wear of spring pressure brakes leads to a gradual increase in what is known as rotational play, as a result of which, in an extreme case, implements driven by the shaft can no longer be held in an exactly defined position during braking. For example, in applications in the robot technology sector, what may happen is that, during braking, one arm of the robot inadvertently flops at least a little way. In other applications, too, such as, for example, in the field of production machines, undesirable movements of this kind after braking may have serious consequences, for example if after emergency braking a conveyor belt still moves a little way further on than intended.

Broad customer groups therefore require a very narrow limitation of the permissible rotational play, since overshooting may lead to enormous damage.

To overcome the wear problem mentioned, it is known to use what are known as permanently excited brakes. However, brakes of this type are very much more costly, and they no longer afford any braking action in the worn state, thus greatly restricting their use as a safety brake, or even making it impossible.

The object on which the invention is based, therefore, is to specify a method for testing a drive arrangement and an accordingly equipped converter, by means of which, on the one hand, a wear of a safety brake can be detected at an early stage and, on the other hand, an unnecessary premature exchange of the safety brake is prevented.

The object is achieved, according to the invention, by means of a method for testing a drive arrangement comprising at least one engine and one brake, with the following steps:
1. Closing of the brake.
2. Driving of the engine out of a known initial angular position counter to the closed brake in a first direction of rotation with a test torque, the test torque being lower than a holding torque for the brake, and the engine being driven counter to the closed brake in the first direction of rotation until a first stop is reached.
3. Determination of a first rotation angle out of the known initial angular position and the first stop; and
4. Comparison of the determined first rotation angle with a first rotation reference angle.

The invention in this case proceeds from the consideration that, while the drive arrangement is in operation, a gradual wear, in particular, of the brake mounting occurs. This wear is reflected in that, even with the brake closed, the drive shaft can still be rotated through a specific rotation angle counter to the closed brake.

This first rotation angle, measured from the known initial angular position to the first stop, is then a measure of a current wear. The first rotation reference angle is to represent a still permissible tolerance, so that, during braking, an undesirably large movement is still prevented. The first stop corresponds to that angular position of the shaft in which the shaft, which is driven counter to the closed brake, comes to a stop.

This first stop may be caused, for example, in that an external toothing of an engine shaft has run through the rotational play and then butts against an internal toothing of a brake disk.

In an advantageous refinement of the invention, the following step is inserted between the abovementioned steps 2) and 3): driving of the engine out of the first stop counter to the closed brake in a second direction of rotation, directed opposite to the first, with the test torque, the engine being driven counter to the closed brake in the second direction of rotation until a second stop is reached. Furthermore, in this case, the following step succeeds the abovementioned step 3): determination of a second rotation angle from the first and the second stop. Finally, the following step also succeeds the abovementioned step 4): comparison of the determined second rotation angle with a second rotation reference angle. In this refinement of the invention, the rotational play is investigated in both directions of rotation. This reliably prevents the situation where a presumably low rotational play is underestimated, for example, due to a small first rotation angle which has been determined. For example, in the case of a very small first rotation angle, an external toothing of the shaft could butt against an internal toothing of the brake disk, which would suggest a low rotational play. In the opposite direction of rotation, however, a different picture may arise, indicating that the second rotation angle is markedly larger than the first rotation angle. Since both rotation angles are compared with a corresponding rotation reference angle, an underassessment of the rotational play is avoided. In this case, the first and the second rotation reference angle may be selected identically.

In a further preferred embodiment, an overall rotation angle is formed from the first and the second rotation angle and is compared with an overall rotation reference angle which is formed from the first and the second rotation reference angle.

The invention leads, furthermore, to a method for testing a drive arrangement comprising at least one engine and one brake, with the following steps:
1. Closing of the brake.
2. Driving of the engine counter to the closed brake in a first direction of rotation with a test torque, the test torque being lower than a holding torque for the brake, and the engine being driven counter to the closed brake in the first direction of rotation until a first stop is reached.
3. Driving of the engine out of the first stop counter to the closed brake in a second direction of rotation, directed opposite to the first, with the test torque, the engine being driven counter to the closed brake in the second direction of rotation until a second stop is reached.
4. Determination of a rotation angle from the first and the second stop; and
5. Comparison of the rotation angle with a rotation reference angle.

In said method, it is not necessary to know the initial angular position of the engine or of the shaft driven by the engine. Instead, a rotational play amplitude between the first and the second stop is determined, without the initial angular position having to be known. This corresponds to a large number of situations occurring in practice, in which said initial angular position is not relevant or is not known. The rotation angle is therefore in this case a measure of the rotational play amplitude. The rotation reference angle is coordinated with a still permissible rotational play amplitude.

Advantageously, in both methods mentioned, the brake is designed as a spring pressure brake.

In the case of a spring pressure brake, during operation, the question of the wear and therefore of the current rotational play arises, so that desired requirements can still be ensured even after a long operating time.

The first and the second stop correspond to an angular position of the engine from which the test torque in the first and the second direction of rotation is no longer sufficient to rotate the engine counter to the holding torque for the brake. Consequently, the engine is at a standstill in the first or the second stop. This standstill may be caused, for example, by the initially mentioned cooperation of an external toothing of the shaft and an internal toothing of the brake disk.

The rotation reference angle is consequently preferably a measure of a permissible rotational play of the brake.

In a particularly preferred embodiment, operation of the drive arrangement after testing is prevented if the comparison indicates an inadmissible deviation.

The method is preferably implemented as a test routine in a converter, which the drive arrangement comprises, for controlling the engine, so that the method steps are carried out by the converter.

The invention leads, furthermore, to a converter for a drive arrangement for controlling at least one engine and one brake, the converter being equipped with software for carrying out at least one of the methods and, if appropriate, preferred embodiments of the latter.

An exemplary embodiment of the invention is illustrated in more detail below.

In the drawing:

The FIGURE shows a drive arrangement to be tested according to the invention by means of the method, details being illustrated only with regard to the brake.

The FIGURE illustrates a brake disk 28 of a brake which has an internal toothing 24. The internal toothing 24 of the brake disk 28 engages into an external toothing 26 of a sleeve 22 which is attached onto a shaft 20. The shaft 20 is driven by an engine, not illustrated in any more detail. The brake disk 28 serves for the safety-compatible braking of the drive arrangement. In a method according to the invention, the shaft 20 is moved by means of the engine, not illustrated, in a first direction of rotation 30 counter to the closed brake, until a first stop is reached. Starting from the first stop, the shaft 20 is then driven in a second direction of rotation 32 by means of the engine, once again counter to the closed brake, until a second stop is reached. A rotational play 34 is then determined from the first and the second stop and is compared with a reference rotational play.

In the event of an overshooting of the reference rotational play, for example, an inadmissibly high wear of the brake can then be inferred. The present exemplary embodiment reproduces, in particular, the use of a spring pressure brake as a safety brake of a drive arrangement.

The method is preferably implemented in a converter of the drive arrangement as a test routine. In this case, the drive is moved to the stop by means of the converter, with the brake closed, with a defined torque (test torque). The test torque must be lower than the holding torque for the brake. Subsequently, the direction of rotation is changed, and the drive is moved toward the stop again at a low rotational speed. The rotation angle is subsequently determined from this and is compared with a stored reference value. If the rotation angle lies above the reference value, then, for example, an operation of the drive can be prevented. At the same time, operator information can also be given. Important advantages of the method may be seen in that a user can use the drive arrangement virtually without any worry. Upon the wear limit being reached, when the rotational play is too high, operation of the drive arrangement can initially be ruled out, in order to avoid risk. In a servicing measure, the wearing parts can then be exchanged, so that the drive is reusable quickly. Furthermore, a premature exchange of the wearing parts is also prevented, since a certain rotational play can usually be accepted, and an inadmissibly high rotational play is reliably detected.

The user of the drive arrangement does not need to switch to costly permanently excited brakes, thus avoiding the risk that, in the event of the wear of the frictional surface of a permanently excited brake, he no longer has any holding torque for the brake available at all. Finally, a method according to the invention can usually be retrofitted cost-effectively in the case of an existing converter of a drive arrangement.

In summary, the invention may be described as follows:

In a method according to the invention for testing a drive arrangement and in an accordingly equipped converter, an actual rotational play of an engine brake, which is preferably designed as a spring pressure brake, is determined and is compared with a permissible rotational play.

In this case, for a test torque which is lower than a holding torque for the brake, movement counter to the closed brake as far as a stop takes place, preferably in both directions of rotation. The test method may in this case be implemented as a test routine in a converter of the drive arrangement.

1.-10. (canceled)

11. A method for testing a drive arrangement, comprising the steps of:
a) closing a brake of the drive arrangement;
b) driving an engine of the drive arrangement from an initial angular position counter to the closed brake in a first direction of rotation with a test torque until a first stop is reached, wherein the test torque is lower than a holding torque for the brake;
c) determining a first rotation angle from the initial angular position and the first stop; and
d) comparing the first rotation angle with a first rotation reference angle,
wherein the method is implemented as a test routine in a converter which forms part of the drive arrangement and which for controlling the engine, so that the method steps are carried out by the converter.

12. The method of claim 11, further comprising the steps of:
driving the engine between the steps b) and c) from the first stop counter to the closed brake in a second direction of rotation with the test torque until a second stop is reached, with the second direction of rotation directed in opposition to the first direction of rotation;
determining a second rotation angle from the first and the second stop after executing the step c);
comparing the second rotation angle with a second rotation reference angle after executing step d).

13. The method of claim 11, further comprising the steps of:
forming an overall rotation angle formed from the first and second rotation angles;
forming an overall rotation reference angle from the first and second rotation reference angles; and
comparing the overall rotation angle with the overall rotation reference angle.

14. The method of claim 11, wherein the brake is designed as a spring pressure brake.

15. The method of claim 11, wherein the first and second stops correspond to an angular position of the engine from which the test torque in the first and second directions of rotation is no longer sufficient to rotate the engine counter to the holding torque for the brake to thereby correspond to a standstill of the engine.

16. The method of claim 11, wherein the rotation reference angle is a measure of a permissible rotational play of the brake.

17. The method of claim 11, wherein operation of the drive arrangement after testing is prevented when the comparing step indicates an inadmissible deviation.

18. A method for testing a drive arrangement, comprising the steps of:
a) closing a brake of the drive arrangement;
b) driving an engine of the drive arrangement counter to the closed brake in a first direction of rotation with a test torque until a first stop is reached, wherein the test torque is lower than a holding torque for the brake;
c) driving the engine from the first stop counter to the closed brake in a second direction of rotation with the test torque until a second stop is reached, with the second direction of rotation directed in opposition to the first direction of rotation;
d) determining a rotation angle from the first and second stops; and
e) comparing the rotation angle with a rotation reference angle, wherein the method is implemented as a test routine in a converter which forms part of the drive arrangement for controlling the engine so that the method steps are carried out by the converter.

19. The method of claim 18, wherein the brake is designed as a spring pressure brake.

20. The method of claim 18, wherein the first and second stops correspond to an angular position of the engine from which the test torque in the first and second directions of rotation is no longer sufficient to rotate the engine counter to the holding torque for the brake to thereby correspond to a standstill of the engine.

21. The method of claim 18, wherein the rotation reference angle is a measure of a permissible rotational play of the brake.

22. The method of claim 18, wherein operation of the drive arrangement after testing is prevented when the comparing step indicates an inadmissible deviation.

23. A converter for a drive arrangement for controlling an engine and a brake, comprising a software for carrying out the method of claim 11.

24. A converter for a drive arrangement for controlling an engine and a brake, comprising a software for carrying out the method of claim 18.
